(19) United States
(12) Patent Application Publication
(10) Pub. No.: US 2011/0089903 A1
(43) Pub. Date: Apr. 21, 2011

(54) METHOD AND DEVICE FOR FEEDING POWER TO WRIST DEVICE

(75) Inventor: Taito Heikkinen, Kajaani (FI)

(73) Assignee: WEARFONE OY, Kajaani (FI)

(21) Appl. No.: 12/918,845

(22) PCT Filed: Feb. 23, 2009
(86) PCT No.: PCT/FI2009/050145

§ 371 Date: Oct. 29, 2010

(30) Foreign Application Priority Data
Feb. 22, 2008 (FI) 20080149

(51) Int. Cl. H02J 7/00

(52) U.S. Cl. 320/126

(57) ABSTRACT

The invention relates to a method and device arrangement for feeding power to a wrist device, such as for example a mobile phone, a GPS device, heart rate monitor or the like. With the help of different embodiments of the invention also wrist devices with relatively high power consumption can be implemented, which devices nevertheless have small external dimensions and are light weighted. Method and device according to the invention for connecting the battery cells to each other enable a more flexible and advantageous structure of the wrist band both on the point of view of usability and manufacture. A varying number of battery cells can be connected and they can vary in size according to needs. Small number of conductors enables a moving and reliable contact surface between battery cells. Depending on the application, two or three contacts are needed, depending on whether the charging voltage is lead to the battery cells separately. The invention is based on that that own electronics unit, switch component and protection circuit are placed in connection with each battery cell. The electronics unit takes care of individual charging of the battery, the switch component connects the battery cell to the voltage feed of the actual device and the protection circuit limits the short circuit current as well as prevents the arise of damages in situations of excess voltage.

The invention relates to a method and device arrangement for feeding power to a wrist device, such as for example a mobile phone, a GPS device, heart rate monitor or the like. With the help of different embodiments of the invention also wrist devices with relatively high power consumption can be implemented, which devices nevertheless have small external dimensions and are light weighted.

A large group of different devices held at the wrist are generally known, which devices have relatively high power consumption. Especially wrist computers and wrist watch phones have to be equipped with rechargeable batteries, physical size of which has to be chosen adequate according to high power consumption. Although the efficiency-weight ratio of the batteries has improved, placing the batteries in the device as one piece is difficult. The size of one large battery increases the external dimensions and weight of the actual device considerably and the product will easily become of a size that is clumsy.

Several batteries can in theory be placed in the wrist band of the device. In that case connecting the batteries electrically to each other in an expedient way becomes the problem. If the batteries are connected together from only their terminals, the small differences in terminal voltages of the batteries cause reciprocal currents between the batteries. One battery with undervoltage can render the whole set of batteries useless. There are problems in connection in series of batteries especially with efficient battery types, such as lithium-ion and lithium polymer batteries, the charging voltage of which has to be kept accurately on the right range. Regulating the charging voltages of batteries connected in series with one regulating circuit is impossible.

For example old-fashioned lead batteries can be connected directly parallel to each other without it causing much disadvantage. In more modern battery types, such as for example in lithium-ion or lithium polymer batteries, there is a considerably smaller internal resistance, because of which direct parallel connection of them causes stronger reciprocal currents between the batteries and therefore loss of power. As devices become smaller and operating times get longer one has to make sure that the energy from the batteries can be utilised in its entirety. A good example of this is devices held at the wrist, in which the deconcentrated placement of batteries in the wrist band enables smaller size of the device.

The wrist band becomes rigid at the batteries and the flexibility needed is achieved by joining the batteries with flexible material or through joints to each other. By using several batteries the individual size of a battery can be decreased, whereby the wrist band can be made more flexible and thinner. As regards to the electrical connecting of the batteries, it is the more difficult the larger number of batteries is wanted to be used in the structure. If separate conductors are lead from each battery cell to the charging control in the actual device, a large number of conductors are needed. Then connecting the batteries in the wrist band with flexible organs, such as conductors or flexible circuit board increases the amount of insulation and at the same time the cross-sectional measure becomes easily a problem. Because of the large number of the conductors the part meant to be flexible becomes more rigid and the reliability of the device arrangement is increasingly difficult to get to a level high enough.

An objective of the device of the invention is to achieve a method and device, with which some of the above mentioned defects can be eliminated and the implementation of the wrist device is solved by placing the batteries in the wrist band. Then the actual device will be of smaller size and the wrist band will also become proportionate in comparison to the actual device. It is possible to implement an adequate volume of the batteries in the device in an inconspicuous way.

Method and device according to the invention for connecting the battery cells to each other enable a more flexible and advantageous structure of the wrist band both on the point of view of usability and manufacture. A varying number of battery cells can be connected and they can vary in size according to needs. Small number of conductors enables a moving and reliable contact surface between battery cells. Depending on the application, two or three contacts are needed, depending on whether the charging voltage is lead to the battery cells separately. The invention is based on that that own electronics unit, switch component and protection circuit are placed in connection with each battery cell. The electronics unit takes care of individual charging of the battery, the switch component connects the battery cell to the voltage feed of the actual device and the protection circuit limits the short circuit current as well as prevents the arise of damages in situations of fault, such as for example in excess or undervoltage.

With the present invention some of the above mentioned problems are solved and some of the shortcomings of prior art are eliminated and battery devices, that can be placed in the wrist band or the like, with better reliability and usability, that are usable diversely in different situations and are of essentially smaller size than prior art, are achieved. The mentioned benefits are achieved with the method and device according to the invention, to which method and device it is characteristic that what is defined in the claims.

Next the invention is described in detail with the help of some advantageous exemplified embodiments and with reference to the accompanying drawings, of which

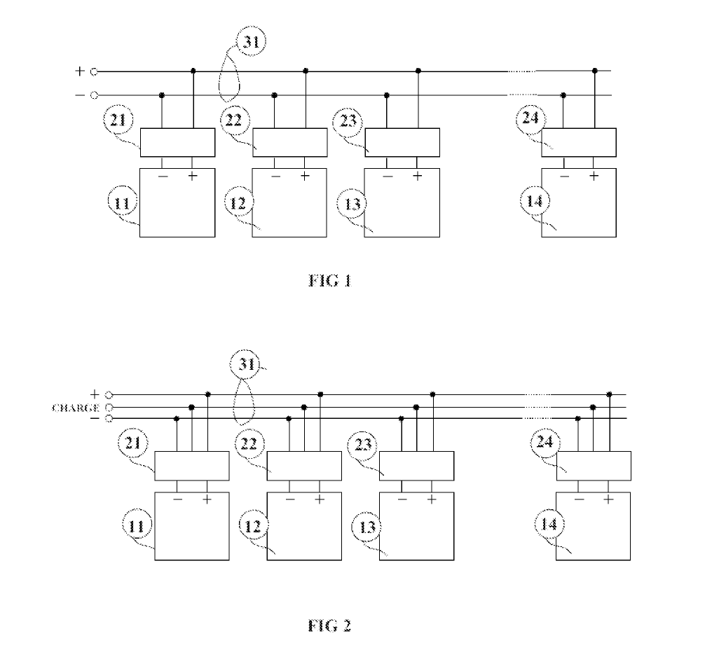

FIG. 1 shows a method, in which the energy feed bus is implemented with two conductors, positive and negative,

FIG. 2 shows a method, in which the energy feed bus is implemented with three conductors, positive, negative and charging voltage,

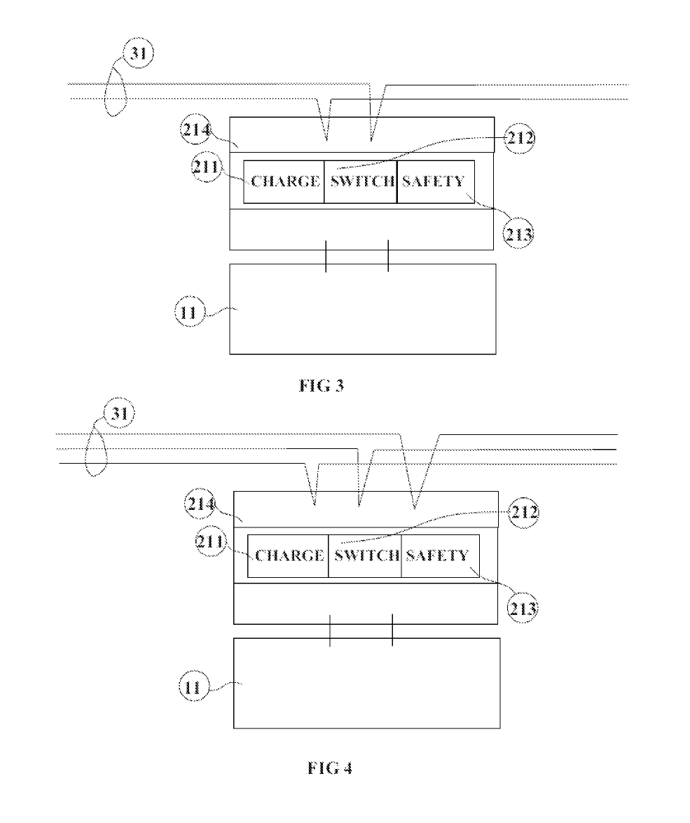

FIG. 3 shows a method, in which a connection with its charging circuit unit is implemented with two conductors,

FIG. 4 shows a method, in which a connection with its charging circuit unit is implemented with three conductors,

FIG. 5 shows an application of the invention, a set of batteries implemented as a metal wrist band, and

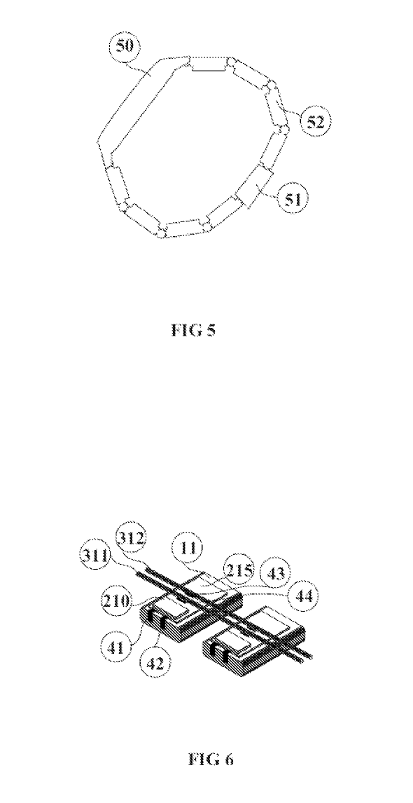

FIG. 6 shows an application on how the connecting of the batteries/set of battery cells to the energy feed bus is done in the method according to the invention,

FIGS. 1-6 show applications of the method according to the invention, in which are included switch and charging circuits 21, 22, 23, 24, battery cells 11, 12, 13, 14 and energy feed bus 31.

Switch and charging circuit 21 consists of electronics components with the connections between them. The function described here can be implemented also with one electronics component or hybrid circuit. Charging circuit 211 measures the voltage of the battery cell and guides power to the battery in a way defined for the battery type. Charging circuit 211 takes also care of that that the battery is not overcharged and lets the battery voltage to rise only to the allowed value. With the help of switch circuit 212 the battery cell is connected to the energy feed bus in a controlled way. When the voltage of the battery is lower than the voltage in the energy feed bus, the battery cell will not be connected nor will it participate to the energy feed in the system. When the voltage in the energy feed bus decreases so that the voltage is at the most the same as battery cell voltage, the battery cell or set of battery cells will start feeding power through the connection circuit to the energy feed bus and through that to the device/devices connected to it. When needed, if it is recommended for the battery type, this electronics part also includes a battery protection circuit 213. The protection circuit disconnects the battery cell, if it recognises for example the battery voltage rising too high or the battery voltage is getting too low, the current between the battery cell and the energy feed bus becomes too high or in other situations, where the battery cell or the surroundings would be in danger.

If the energy feed bus has, instead of three, two conductors, the switch and charging circuit is a little more complicated. The electronics part has to then be able to prevent that that the battery cell/set of battery cells with higher battery voltage does not start charging the cell or set of cells with lower battery voltage in usage situation, when it is not meant to charge the battery. The lower voltage in the battery or battery cell can be caused by the fact that it is only emptier than the others in a natural way or it is damaged.

In connection with the energy feed bus, by adding conductors or by modulating information on the same conductors, it is possible to get other functions, such as for example temperature measurement, voltage measurement, or to be able to connect sensors relating to each application.

The interspaces between battery cells 11-14 are implemented as flexible or they have mechanical pivoting joints. The battery cells can also be connected to a flexible material or there can be flexible material between them. In some embodiments the battery cells can be rigidly fastened to each other. The figure shows the connection of four individual battery cells to the energy feed bus, but depending of the application and the energy requirement the number of them can be any. Likewise, the battery cell presented here can be in itself already a unit formed by several battery cells, which is charged and discharged like one cell.

The energy feed bus 31 between battery units is implemented in an embodiment with slide contacts (not shown) between batteries 11-14. As conductor/conductors of the bus electrically conductive body of the wrist band can be used. As the conductor instead of the actual cable also a flexible circuit board or other conductive material can be used.

When an individual battery is broken the unbroken batteries feed energy to the energy feed bus 31 and trough it to the connected device. The charging circuit recognises the bad battery cell or set of battery cells and does not charge it with full capacity.

The energy feed bus 31 can run in two directions from the wrist device, which energy feed bus can both have one or several battery cells 11-14. In an advantageous application only one energy feed bus 31 runs from the wrist device, whereby it is for example easier to seal the device.

The method for charging and discharging energy from battery cells 11-14, that are placed string-like to wrist band, belt or the like functions as follows. The battery cells are charged through the energy feed bus 31, whereby the switch and charging circuit 21-24 of each battery regulates the charging voltage of each battery. The charging circuits control the magnitude of charging current, detect the levels of terminal voltages of batteries and the magnitudes of currents. Due to the regulation each battery can be charged as full as possible. When using the electrical energy contained by the batteries, the circuits 21-24 control the discharge of the batteries so, that they discharge as evenly as possible. Then the electrical energy stored can be utilised comprehensively. Battery arrangement according to the method enables the maximal usage of battery capacity, which is especially important when small sized batteries are in question. A set of battery cells equipped with effective control can be sized small in volume and weight, whereby the relative charging capacity of batteries increases.

FIG. 5 shows an application of the invention, set of batteries 52 implemented as a metal wrist band, in which there are mechanical joints between the battery units and the set of batteries feeds the device 50, which in this case is a wrist watch phone. In the figure from both sides of the device extends set of batteries 52, but the other implementation alternative is that the energy feed bus runs only in one direction from the device. Then the advantage is gained in that the energy feed bus does not need to run to several directions from the actual device, which causes a lead-in or other connection type to the device, which is either more expensive to implement or problematic with regard to sealing. In the wrist band also other suitable materials instead of metal can be used.

FIG. 6 shows an application on how the connecting of the batteries/battery cells to the energy feed bus is done in the method according to the invention. The energy feed bus can be implemented with the minimum of two conductors. When the mechanical structure allows, as the conductor/conductors also other mechanical structure can be used, such as for example body structure (not shown in the figure). Conductors 311 and 312 of the energy feed bus are indicated in the figure, which conductors have been electrically connected by soldering or by some other means to the electronics unit 215, which includes charging, switch and protection items 210. The electronics unit connects to the battery or set of battery cells through electrically conductive connections 41 and 42. The energy feed bus can be implemented with flexible materials, such as for example with cables or flexible circuit board. Mechanically the structure can vary with regard to the space in use, for example a battery or a set of battery cells can reside side by side with the electronics unit, whereby a flatter implementation can be achieved.

Figures and the description accompanying them is meant only to illustrate the present invention. In its details the invention can vary within the limits of the accompanying claims and the inventive idea presented in the description of the invention. It is obvious to the man skilled in the art that the dimensions and detailed solutions may vary according to the application. Further it is obvious to the man skilled in the art that the embodiment of the invention may vary within the limits set by conditions of use, customer needs, series production methods and production solutions introduced in mass production.

1. A method for feeding power to a wrist device and the like, in which method:
battery cells (11, 12, 13, 14) have been connected to each other electrically and mechanically, and
each battery cell (11, 12, 13, 14) is charged with a unit specific electronics unit (21, 22, 23, 24), that resides in connection with the battery cell, which unit takes care of the individual charging of the battery cell,
characterised in that:
each of the parallel connected battery cells is charged and discharged through an energy feed bus (31), to which the battery cell is connected with a battery cell specific switch (212), and that
a functional state of an individual battery cell is controlled with the battery cell specific switch (212).

2. The method according to claim 1, characterised in that each electronics unit (21, 22, 23, 24) is equipped with a battery specific protection circuit (213), which limits short circuit current and prevents the arise of damage in a situation of fault.

3. The method according to claim 1, characterised in that the battery cells (11, 12, 13, 14) are joined with flexible elements.

4. The method according to claim 1, characterised in that between the battery cells (11, 12, 13, 14) pivoting mechanical joints are used.

5. The method according to claim 1, characterised in that the battery cells (11, 12, 13, 14) are fastened to the flexible material.

6. The method according to claim 1, characterised in that between the batteries (11, 12, 13, 14) there is one or several slide contacts, with the help of which is implemented in part or in whole the energy feed bus (31) between the battery units.

7. The method according to claim 1, characterised in that the energy feed bus (31) with two conductors is implemented so that as the second conductor of the bus electrically conductive body of a wrist band is used.

8. The method according to claim 1, characterised in that as the conductor, instead of actual cable, a flexible circuit board or other conductive material is used.

9. The method according to claim 1, characterised in that if individual battery cells (11, 12, 13, 14) are broken, then the unbroken battery cells feed energy to the energy feed bus (31) and through that to the device connected to it, and that the charging circuit (211) recognises a weak battery cell/set of battery cells and will not charge the weak battery with full capacity.

10. The method according to claim 1, characterised in that an energy feed bus (31) runs from the wrist device to two direction, in both of which buses there is one or several battery cells (11, 12, 13, 14).

11. The method according to claim 1, characterised in that the battery cells (11, 12, 13, 14) are connected to each other rigidly.

12. A device (21, 22, 23, 24) for feeding power to wrist devices or the like, characterised in that it comprises an energy feed bus (31), whereto battery cells (11, 12, 13, 14) and their switch and charging circuits (21, 22, 23, 24) of the battery cells are connected in parallel, which circuits are arranged to control a functional state of an individual battery cell.

13. The device according to claim 12, characterised in that battery cell specific switch and charging circuits (21, 22, 23, 24) comprise a charging circuit (211), connection circuit (212) and a protection circuit (213).

14. The device according to claim 12, characterised in that the energy feed bus (31) comprises either two or three conductors.

15. The device according to claim 12, characterised in that in connection with the energy feed bus (31) with additional conductors or by modulating information on the same conductors is implemented thermal measurement, voltage measurement or is connected sensors belonging to some application.

16. The device according to claim 12, characterised in that one or several energy feed buses (31) run from the wrist device (50).

17. The device according to claim 12, characterised in that a set of batteries (52) implemented as a wrist band comprises mechanical joints between battery units and that the set of batteries in the wrist band feeds the device (50).
